(19) United States
(12) Patent Application Publication
(10) Pub. No.: US 2018/0353012 A1
(43) Pub. Date: Dec. 13, 2018

(54) DEVICE FOR GRINDING A SEASONING PRODUCT BY MEANS OF A MILL AND MILL COMPRISING SUCH A GRINDING DEVICE

(71) Applicant: PSP, Quigney (FR)

(72) Inventors: Maurice LAUZET, Chencey Buillon (FR); Christian MESNIER, Chouzelot (FR)

(21) Appl. No.: 15/735,171

(22) PCT Filed: Jun. 3, 2016
(86) PCT No.: PCT/FR16/51330

§ 371 Date: Dec. 9, 2017

(30) Foreign Application Priority Data
Jun. 4, 2015 (FR) PCT/FR15/51485
Jun. 26, 2015 (FR) 1555926
Aug. 25, 2015 (FR) 1557892

(51) Int. Cl. A47J 42/04; A47J 42/38

(52) U.S. Cl. CPC A47J 42/04; A47J 42/38

(57) ABSTRACT

The milling device for a seasoning product, in particular for salt, a spice or a condiment includes a mill, an annular bowl and a frustoconical bulb able to be rotated in the bowl, when the mill is actuated. An axial rod is used and connected to its apex. The inner face of the bowl and the outer face of the bulb is provided with teeth. There is a flange for securing to the mill, the flange being in the shape of a “U” having two lateral branches connected by a transverse branch. The distance between the two lateral branches is adjusted to the diameter of the bowl. There is a device for aligning the rotation axis of the bulb with the axis of the bowl.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a device for milling a seasoning product, in particular salt, a spice or a condiment, using a mill, said milling device including an annular bowl and a frustoconical bulb able to be rotated in said bowl when the mill is actuated, using an axial rod connected to its apex, the inner face of said bowl and the outer face of said bulb being provided with teeth, said milling device also including a flange for securing to said mill, said flange being in the shape of a “U” including two lateral branches connected by a transverse branch, the distance comprised between the two lateral branches being adjusted to the diameter of said bowl.

The invention also relates to a mill for milling a seasoning product, in particular salt, a spice or a condiment, equipped with such a milling device.

The aim of the present invention is to propose an improvement to the traditional milling devices making it possible to improve the precision of their mechanism irrespective of the nature of its component material.

### 2. Description of Related Art Including Information Disclosed Under 37 CFR 1.97 and 37 CFR 1.98.

Traditionally, the component elements of the milling device of a spice mill can all be manufactured from a same material or from a different material, this material being able to consist of a metal, a ceramic, a plastic or a composite material, or any material having equivalent characteristics. The nature of the selected material is crucial and is in particular selected based on the type of seasoning product for which the mill is designed and characteristics that one wishes to impart thereto. Indeed, the nature of the materials conditions both the reliability of the milling mechanism and its ergonomics, the quality of the obtained milling and the lifetime of the mill. Furthermore, the aesthetic aspect of the mill is also determined by the selected type of material.

It has been possible to observe that in the milling devices of the type indicated in the preamble, the teeth present on the inner face of the bowl and on the outer face of the bulb may tend to disintegrate due to untimely contact between these two parts during the rotation of the bulb relative to the bowl. Indeed, as designed at this time, the mechanism does not make it possible to guarantee perfect centering of the bulb in the bowl at all times. Such disintegration of the teeth occurs more readily when they are made from a brittle material such as ceramic. This is detrimental to the longevity and reliability of the mechanism and is particularly bothersome in terms of results, since particles of material can be found mixed with the powdered salt, spice or condiment produced, and therefore pollute it both aesthetically and qualitatively. Additionally, the material particles may be harmful if ingested.

### BRIEF SUMMARY OF THE INVENTION

Consequently, the present invention aims to propose a device for milling a seasoning product, in particular salt, a spice or a condiment, in a mill, having a structure such that any contact between the bulb and the bowl is avoided during the rotation of the bulb in the bowl. Thus, the risk of disintegration of the teeth present on the inner face of the bowl and on the outer face of the bulb is eliminated, which makes it possible to improve the longevity of the mill and to guarantee the quality of the obtained milling.

To that end, the invention relates to a milling device of the type indicated in the preamble, characterized in that it includes means for aligning the rotation axis of the bulb with the axis of the bowl. Such a feature advantageously makes it possible to avoid any contact between these two parts during the rotation of the bulb in the bowl, since the bulb is then perfectly centered at all times relative to the bowl.

According to one preferred alternative embodiment, the milling device according to the invention includes a centering disk with a diameter identical to that of said bowl, including a central orifice for the passage of said axial rod, and at least one lumen for the passage of the seasoning product, on the one hand, and means for locking the rotation of the centering disk relative to said bowl, on the other hand.

According to one feature of the invention, the means for locking the rotation of the centering disk relative to said bowl may include at least one pair of tabs extending diametrically opposite one another on the edge of said disk in the extension of its lower face and at least one pair of notches made in a diametrically opposite manner on the upper edge of said bowl and having a shape complementary to that of said tabs.

Furthermore, the invention also sets out that the central orifice of said disk preferably has a circular section complementary to that of the base of said axial rod.

Another advantageous feature of the invention is defined by the fact that the lower face of the bulb includes a female or male means, with an axis aligned with that of the rod, able to be mounted rotatably relative to a complementary male or female means centered on the transverse branch of said flange.

In this case, according to one possible alternative embodiment, said flange may include a cylindrical stud centered on the upper face of its transverse branch, while the lower face of the bulb may include an indentation with a shape complementary to that of the stud and with an axis aligned with that of the axial rod.

The milling device according to the invention is also characterized in that it includes means for locking the rotation of said bowl relative to said flange.

In this case, said bowl may include a pair of notches formed in a diametrically opposite manner on its lower edge, while said flange may include a pair of stops with a shape complementary to that of said notches and each extending at an angle formed between the transverse branch of the flange and one of its lateral branches.

The present application also relates to a mill for milling a seasoning product, in particular salt, a spice or a condiment, characterized in that it includes a milling device as defined above.

According to one alternative embodiment more specifically adapted to certain types of seasoning products, the mill according to the invention may include means for mixing and/or driving the seasoning product toward the bowl.

### BRIEF DESCRIPTION OF THE SEVERAL VIEWS OF THE DRAWINGS

The invention will be better understood, and other features and advantages of the invention will appear in light of the following description of one example embodiment provided non-limitingly. The description is to be read in connection with the appended drawings, in which:

FIG. 1 illustrates an exploded view of a milling device according to the invention,

FIG. 2 illustrates an exploded view taken from a different angle of the milling device of FIG. 1, and in which the axial rod is not shown, for improved clarity,

FIG. 3 is a partial sectional view of the milling device of FIG. 1 in the assembled position,

FIG. 4 illustrates an exploded view of a mill for milling a seasoning product equipped with the milling device of FIG. 1,

FIG. 5 illustrates a sectional view of the mill of FIG. 4 in the assembled position.

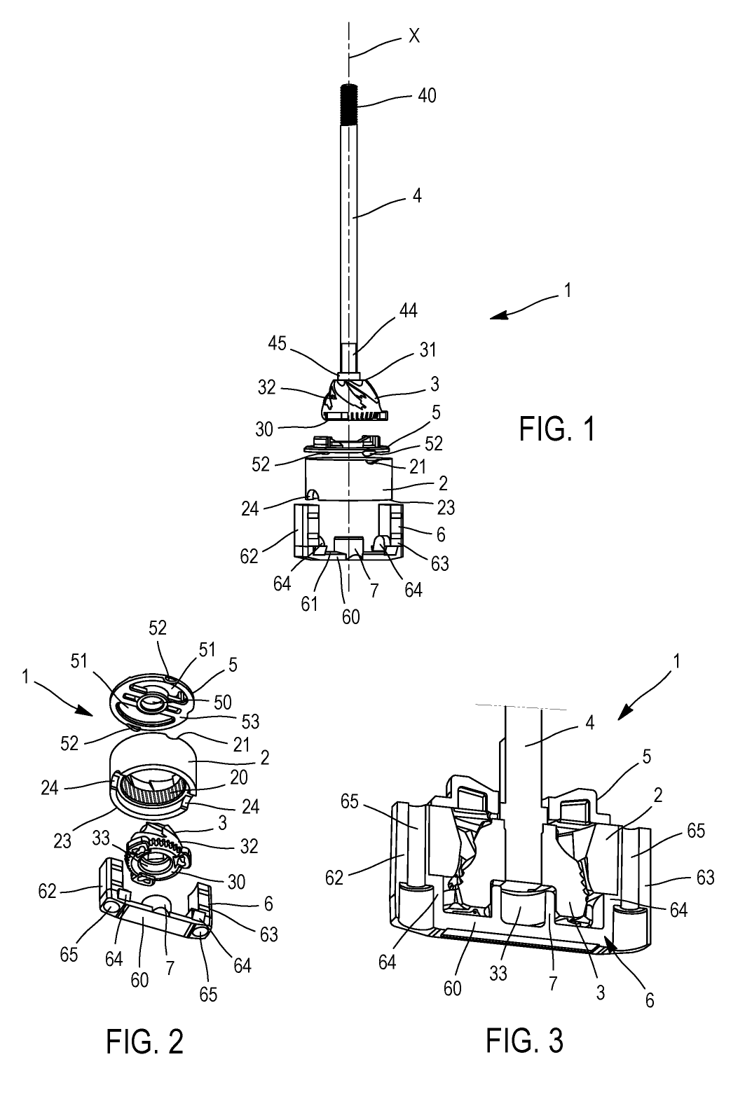

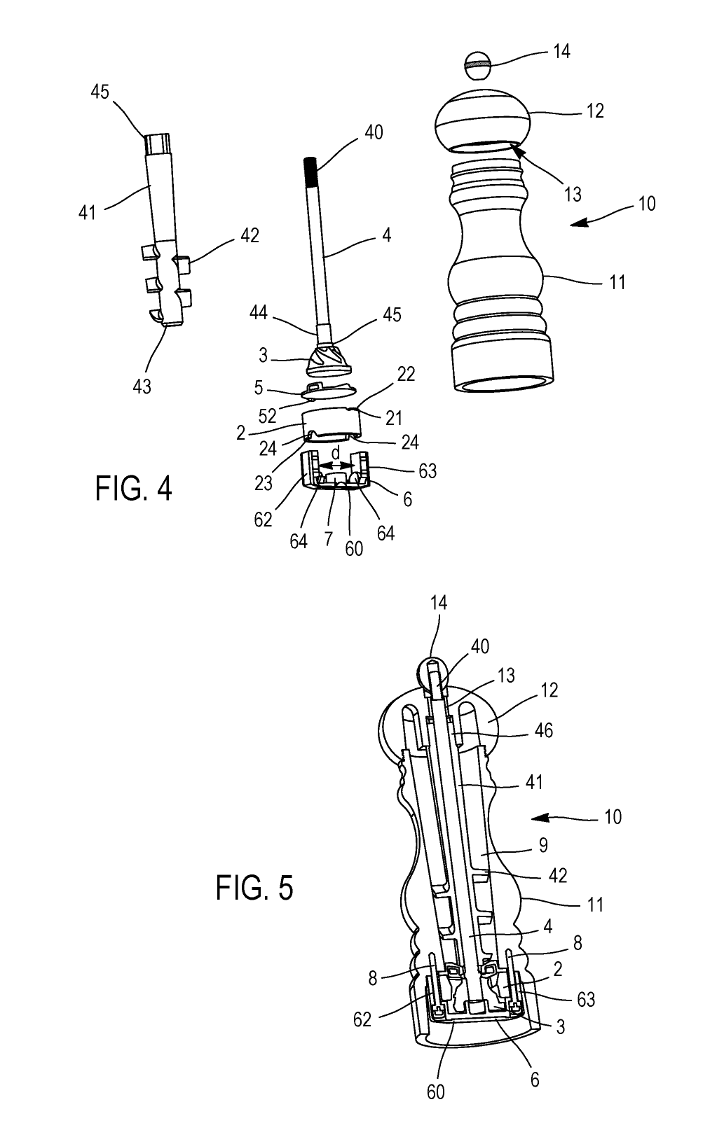

### DETAILED DESCRIPTION OF THE INVENTION

In reference to the figures, the present invention relates to a milling device 1 for a seasoning product traditionally including an annular bowl 2 and a frustoconical bulb 3 whereof the apex 31 is extended by an axial rod 4.

A flange 6 makes it possible to secure the assembly formed by the bowl 2, the bulb 3 connected to the axial rod 4 at the body 11 of a mill 10, using screws 8. Indeed, the flange 6 is in the shape of a “U” including two lateral branches 62, 63 connected by a transverse branch 60. The distance d comprised between the two lateral branches 62, 63 is adjusted to the diameter of the bowl 2.

Thus, in the assembled position of the milling device 1 on the mill 10, the transverse branch 60 of the flange 6 is bearing against the lower edge 23 of the bowl 2 and its lateral branches 62, 63 are bearing against the outer face of the bowl 2.

The screws 8 for fastening the flange 6 to the body 11 of the mill 10 are traditionally inserted into through passages 65 formed in each of the lateral branches 62, 63 of the flange 6, then screwed in a flange inwardly included by the body 11 of said mill 10.

Indeed, the latter is hollow and arranges a reservoir 9 for a seasoning product communicating with the bowl 2 when the milling device 1 is assembled on the mill 10.

Furthermore, the milling device 1 according to the invention includes means for locking the rotation of the bowl 2 relative to the flange 6. In the illustrated alternative embodiment, they are defined by a pair of notches 24 formed in a diametrically opposite manner on the lower edge 23 of the bowl 2 and a pair of stops 64 with a shape complementary to that of the notches 24 included by the flange 6 and each extending at an angle formed between its transverse branch 60 and one of its lateral branches 62, 63. The curved shape of the stops 64 and the notches 24 in the illustrated example further makes it possible to facilitate the proper positioning of the flange 6 relative to the bowl 2.

The mill 10 also includes a cap 12, topping the body 11 and mounted rotatably on the latter. The cap 12 has an inner through passage centered on the axis of the mill 10, intended to be traversed by the axial rod 4.

The latter has a threaded free end 40 on which, when it emerges from said passage 13, an adjusting button 14 is traditionally screwed more or less tightly.

According to one possible alternative embodiment, the bowl 2 and the bulb 3 can be manufactured from ceramic, this material having the advantage of being particularly solid and withstanding permanent contact with a food product that may prove to be corrosive, in particular such as salt. The axial rod 4 and the flange 6 are subject to fewer stresses than the bowl 2 and the bulb 3. As a result, they may advantageously be made from a plastic material, which makes it possible to limit the production cost of the device 1, and consequently of a mill 10. Of course, any other material having equivalent properties may also be considered.

In the illustrated alternative embodiment, the mill 10 also includes a tube 41 able to be engaged on the axial rod 4 and provided with a plurality of blades 42 distributed on its outer wall and allowing the mixing and driving of the seasoning product toward the bowl 2. This tube 41 is mounted locked in rotation relative to the axial rod 4 and to that end has a square inner section at its lower end 43, able to cooperate with a portion 44 having a complementary square section included by the axial rod 4. The tube 41 is also mounted locked in rotation relative to the cap 12 of the mill 10 and to that end includes a square outer section at its upper end 46 able to cooperate with a portion having a complementary square inner section included by the through passage 13 of the cap 12.

Owing to such a mill structure 10, the actuation by a user of its cap 12 results in rotating the axial rod 4 and therefore the bulb 3 relative to the bowl 2.

This rotational movement makes it possible to orient the seasoning product, falling by gravity from the reservoir 9 formed by the body 11 of the mill 10 toward the bowl 2, toward the teeth 32, 20 respectively included by the outer face of the bulb 3 and the inner face of the bowl 2. The seasoning product is milled by friction on the teeth 32, 20 and ultimately discharged outside the mill 10 in the form of a more or less fine powder.

According to the invention, the milling device 1 further includes a centering disk 5 with a diameter identical to that of the bowl 2, including a central orifice 50 allowing the passage of the axial rod 4, said orifice 50 having a circular section complementary to the base 45 of the axial rod 4.

The centering disk 5 also has two half-moon-shaped lumens 51, symmetrical relative to its axis, and allowing the passage of the seasoning product contained in the reservoir 9 of the mill 10 and therefore its introduction into the bowl 2.

The centering disk 5 is mounted locked in rotation relative to the bowl 2 and to that end includes a pair of tabs 52 extending diametrically opposite one another on its edge in the extension of its lower face 53 and intended to be housed in a pair of notches 21 made in a diametrically opposite manner on the upper edge 22 of the bowl 2 and having a shape complementary to that of said tabs 52.

The presence of the centering disk 5 makes it possible to align the axial rod 4 and therefore the bulb 3 with the axis X of the bowl 2. The centering disk 5 thus makes it possible to lock the apex 31 of the bulb 3 in position and to prevent any untimely translational movement of the axial rod 4 along an axis perpendicular to the axis X of the bowl 2.

In the illustrated alternative embodiment, the flange 6 also includes a cylindrical stud 7 centered on the upper face 61 of its transverse branch 60, while the lower face 30 of the bulb 3 includes an indentation 33 complementary to the cylindrical stud 7 and with an axis aligned with that of the axial rod 4. This feature also makes it possible to lock the bulb 3 in position and to guarantee the alignment of its axis with that of the bowl 2 over its entire height.

It clearly emerges from the foregoing that the milling device 1 according to the invention includes technical means making it possible to achieve the goal set out in the preamble, which is to guarantee centering of the bulb 3 relative to the bowl 2 at any time during the actuation of the mill 10. Owing to such a feature, the longevity and reliability of the milling device 1 according to the invention are improved, as well as the quality of the collected food product powder.

It should be noted that the milling device 1 according to the invention is designed as a universal module suitable for adapting to a large number of mills having different shapes and characteristics.

Of course, many changes can be made to the examples described above without going beyond the scope of the present invention.

1. A milling device for a seasoning product, comprising:
a mill;
an annular bowl; and
a frustoconical bulb able to be rotated in said bowl when the mill is actuated, using an axial rod connected to its apex, the inner face of said bowl and the outer face of said bulb being provided with teeth; and
a flange for securing to said mill, said flange being in the shape of a “U” including two lateral branches connected by a transverse branch, the distance between the two lateral branches being adjusted to the diameter of said bowl, and being comprised of means for aligning the rotation axis of the bulb with the axis of the bowl.

2. The milling device, according to claim 1, further comprising: a centering disk with a diameter identical to that of the bowl, being comprised of a central orifice for the passage of said axial rod, and at least one lumen for the passage of the seasoning product, said milling device further comprising means for locking the rotation of the centering disk relative to said bowl.

3. The milling device, according to claim 2, wherein the means for locking the rotation of the centering disk relative to said bowl comprises at least one pair of tabs extending diametrically opposite one another on the edge of said centering disk in the extension of its lower face and at least one pair of notches made in a diametrically opposite manner on the upper edge of said bowl and having a shape complementary to that of said tabs.

4. The milling device, according to claim 2, wherein the central orifice of said centering disk has a circular section complementary to that of the base of said axial rod.

5. The milling device, according to claim 1, wherein the lower face of the bulb comprises a female or male means, with an axis aligned with that of the axial rod, able to be mounted rotatably relative to a complementary male or female means centered on the transverse branch of said flange.

6. The milling device, according to claim 5, wherein said flange comprises a cylindrical stud centered on the upper face of its transverse branch, while the lower face of the bulb comprises an indentation complementary to the cylindrical stud and with an axis aligned with that of the axial rod.

7. The milling device, according to claim 5, further comprising means for locking the rotation of said bowl relative to said flange.

8. The milling device, according to claim 7, wherein said bowl comprises a pair of notches formed in a diametrically opposite manner on its lower edge, while said flange comprises a pair of stops with a shape complementary to that of said notches and each extending at an angle formed between the transverse branch of the flange and one of its lateral branches.

9. A mill for milling a seasoning product, comprising: a milling device according to claim 1.

10. The mill, according to claim 9, further comprising means for mixing and/or driving the seasoning product toward the bowl.
